(19) United States
(12) Patent Application Publication
(10) Pub. No.: US 2015/0331095 A1
(43) Pub. Date: Nov. 19, 2015

(54) SOUND DETECTION DEVICE AND SOUND DETECTION METHOD

(71) Applicant: TOYOTA JIDOSHA KABUSHIKI KAISHA, Toyota-shi, Aichi (JP)

(72) Inventors: Jun SATO, Susono-shi, Shizuoka (JP); Ryuji FUNAYAMA, Yokohama-shi, Kanagawa (JP); Tomoya TAKATANI, Nissin-shi, Aichi (JP); Toshiki KINDO, Yokohama-shi, Kanagawa (JP); Hideo FUKAMACHI, Hadano-shi, Kanagawa (JP); Hiroaki SHIMIZU, Susono-shi, Shizuoka (JP)

(73) Assignee: TOYOTA JIDOSHA KABUSHIKI KAISHA, Toyota-shi, Aichi (JP)

(21) Appl. No.: 14/654,326

(22) PCT Filed: Dec. 26, 2012
(86) PCT No.: PCT/JP2012/083701

§ 371 Date: Jun. 19, 2015

(51) Int. Cl. G01S 11/14

(52) U.S. Cl. CPC G01S 11/14

(57) ABSTRACT

A sound detection device is provided in a moving body and includes a sound detection unit configured to detect an ambient sound of the moving body and a determination unit configured to determine at least one of the presence of a sound source to be detected around the moving body, the approach of the sound source to the moving body, and the separation of the sound source from the moving body, on the basis of a degree of correlation between sound pressure information of a first preset frequency band in the ambient sound detected by the sound detection unit and sound pressure information of a second frequency band different from the first frequency band in the ambient sound detected by the sound detection unit.

### TECHNICAL FIELD

The present invention relates to a sound detection device that is provided in a moving body and a sound detection method using a sound detection device provided in a moving body.

### BACKGROUND ART

For example, Japanese Unexamined Utility Model (Registration) Application Publication No. 5-92767 discloses a sound detection device and a sound detection method that determine the presence and approach of a sound source to be detected, such as a nearby vehicle, on the basis of a change in the sound pressure of a detected sound in a specified frequency band over time.

### CITATION LIST

### Patent Literature

[Patent Literature 1] Japanese Unexamined Utility Model (Registration) Application Publication No. 5-92767

### SUMMARY OF INVENTION

### Technical Problem

However, for example, when not the sound pressure of a sound to be detected, such as a traveling sound of a nearby vehicle, but the sound pressure of background noise increases, the erroneous determination that the sound source to be detected is present or approaches is likely to be made. Therefore, it is necessary to improve the accuracy of determination.

An object of the invention is to provide a sound detection device and a sound detection method that can accurately determine the presence, approach, or separation of the sound source to be detected.

### Solution to Problem

According to an aspect of the invention, there is provided a sound detection device that is provided in a moving body and includes: a sound detection unit configured to detect an ambient sound of the moving body; and a determination unit configured to determine at least one of the presence of a sound source to be detected around the moving body, the approach of the sound source to the moving body, and the separation of the sound source from the moving body, on the basis of a degree of correlation between sound pressure information of a first preset frequency band in the ambient sound detected by the sound detection unit and sound pressure information of a second frequency band different from the first frequency band in the ambient sound detected by the sound detection unit.

According to the sound detection device of the above-mentioned aspect of the invention, at least one of the presence of the sound source to be detected, the approach of the sound source to the moving body, and the separation of the sound source from the moving body is determined on the basis of the degree of correlation between the sound pressure information of the first frequency band and the sound pressure information of the second frequency in the ambient sound. Here, there is a large difference in frequency characteristics between the sound to be detected and background noise. Therefore, when a specified frequency band is set to the first frequency band and a frequency band other than the specified frequency band is set to the second frequency band, it is possible to determine whether the sound to be detected is included in the ambient sound, on the basis of the degree of correlation between the sound pressure information of the first frequency band and the sound pressure information of the second frequency band. As a result, it is possible to accurately determine the presence, approach, or separation of the sound source to be detected.

The determination unit may determine that the sound source approaches the moving body when the degree of correlation between the sound pressure information items decreases over time and may determine that the sound source is separated from the moving body when the degree of correlation between the sound pressure information items increases over time. According to this structure, it is possible to determine the approach or separation of the sound source on the basis of a change in the degree of correlation between the sound pressure information items of different frequency bands over time.

The sound detection device according to the above-mentioned aspect of the invention may further include: a generation unit configured to generate a sound other than a sound from the sound source on the basis of the ambient sound detected by the sound detection unit; and a removal unit configured to remove the sound generated by the generation unit from the detected ambient sound when it is determined that the sound source is not present. According to this structure, since the sound other than the sound from the sound source to be detected is removed from the ambient sound, it is possible to accurately determine the presence of the sound source to be detected even in a situation in which background noise is dominant.

The sound detection device according to the above-mentioned aspect of the invention may further include: a second determination unit configured to determine whether the sound detection device is in a situation in which the sound detection device can detect the sound source, on the basis of the detection result of the sound source and the sound pressure of the ambient sound detected by the sound detection unit. According to this structure, it is possible to determine whether the sound detection device is in the situation in which the sound detection device can detect the sound to be detected, on the basis of the detection result of the sound source to be detected and the sound pressure of the ambient sound.

The determination unit may be more likely to determine that the sound source is present as the degree of correlation between the sound pressure information items decreases.

The degree of correlation between the sound pressure information items may be calculated on the basis of at least one of the continuity of an intensity distribution, a degree of approximation of the shapes of probability density distributions, and scale parameters of the probability density distributions between a sound in the first frequency band and a sound in the second frequency band.

The determination unit may determine at least one of the presence of the sound source, the approach of the sound source to the moving body, and the separation of the sound source from the moving body, on the basis of a degree of correlation among the sound pressure information of the first frequency band, the sound pressure information of the second frequency band, and sound pressure information of a third frequency band different from the first and second frequency bands in the ambient sound detected by the sound detection unit. According to this structure, even when there is a little overlap between the frequency characteristics of a sound from a sound source other than the sound source to be detected and the frequency characteristics of the sound to be detected, it is possible to accurately determine the presence, approach, or separation of the sound source to be detected, on the basis of the degree of correlation among the sound pressure information items of three or more different frequency bands.

The moving body may be a vehicle.

According to another aspect of the invention, there is provided a sound detection method using a sound detection device provided in a moving body. The sound detection method includes: a sound detection step of detecting an ambient sound of the moving body; and a determination step of determining at least one of the presence of a sound source to be detected around the moving body, the approach of the sound source to the moving body, and the separation of the sound source from the moving body, on the basis of a degree of correlation between sound pressure information of a first preset frequency band in the ambient sound detected in the sound detection step and sound pressure information of a second frequency band different from the first frequency band in the ambient sound detected in the sound detection step. Therefore, when a specified frequency band is set to the first frequency band and a frequency band other than the specified frequency band is set to the second frequency band, it is possible to determine whether the sound to be detected is included in the ambient sound, on the basis of the degree of correlation between the sound pressure information of the first frequency band and the sound pressure information of the second frequency band. As a result, it is possible to accurately determine the presence, approach, or separation of the sound source to be detected.

### Advantageous Effects of Invention

According to the invention, it is possible to provide a sound detection device and a sound detection method that can accurately determine the presence, approach, or separation of the sound source to be detected.

### BRIEF DESCRIPTION OF DRAWINGS

FIG. 1 is a block diagram illustrating a sound detection device according to a first embodiment of the invention.

FIG. 2 is a flowchart illustrating a sound detection method according to the first embodiment.

FIG. 3 is a diagram illustrating a probability density distribution which varies depending on whether there is a traveling sound included in an ambient sound.

FIG. 4 is a diagram illustrating a change, in a scale parameter, which varies depending on whether there is a traveling sound included in the ambient sound, over time.

FIG. 5 is a diagram illustrating an amplitude spectrum and a probability density distribution when the traveling sound is not included.

FIG. 6 is a diagram illustrating an amplitude spectrum and a probability density distribution when the traveling sound is included.

FIG. 7 is a block diagram illustrating a sound detection device according to a second embodiment of the invention.

FIG. 8 is a flowchart illustrating a sound detection method according to the second embodiment.

FIG. 9 is a block diagram illustrating a sound detection device according to a third embodiment of the invention.

FIG. 10 is a flowchart illustrating a sound detection method according to the third embodiment.

FIG. 11 is a block diagram illustrating a sound detection device according to a fourth embodiment of the invention.

FIG. 12 is a flowchart illustrating a sound detection method according to the fourth embodiment.

FIG. 13 is a diagram (⅕) illustrating an amplitude spectrum and a probability density distribution in various situations.

FIG. 14 is a diagram (⅖) illustrating an amplitude spectrum and a probability density distribution in various situations.

FIG. 15 is a diagram (⅗) illustrating an amplitude spectrum and a probability density distribution in various situations.

FIG. 16 is a diagram (⅘) illustrating an amplitude spectrum and a probability density distribution in various situations.

FIG. 17 is a diagram (5/5) illustrating an amplitude spectrum and a probability density distribution in various situations.

FIG. 18 is a block diagram illustrating a sound detection device according to a fifth embodiment of the invention.

FIG. 19 is a flowchart illustrating a sound detection method according to the fifth embodiment.

### DESCRIPTION OF EMBODIMENTS

Hereinafter, sound detection devices and sound detection methods according to embodiments of the invention will be described in detail with reference to the accompanying drawings. In the description of the drawings, the same components are denoted by the same reference numerals and the description thereof will not be repeated. A case in which the sound detection devices and the sound detection methods according to the embodiments of the invention are applied to a vehicle which is an example of a moving body will be described below.

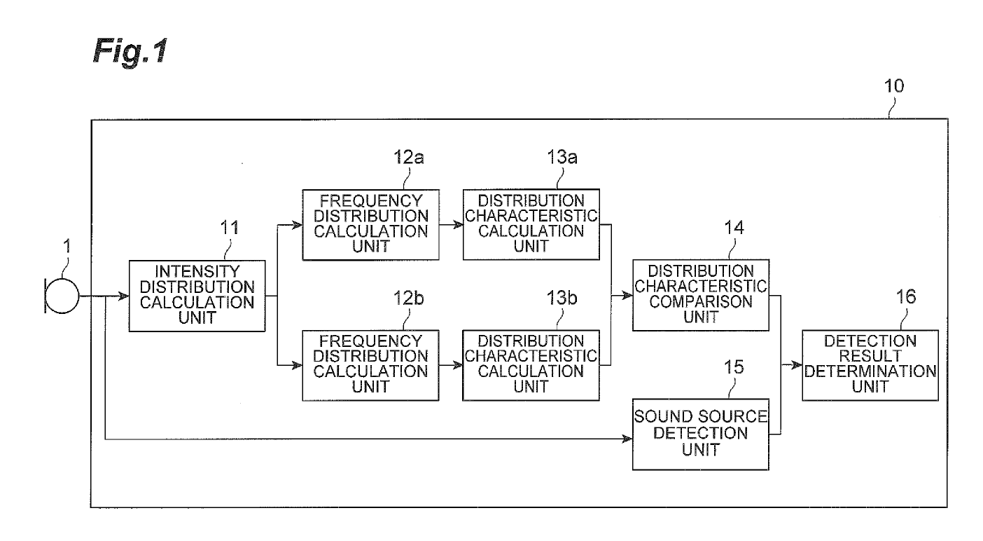

First, a first embodiment of the invention will be described with reference to FIGS. 1 to 6.

In the related art, in the detection of a nearby vehicle, for example, when not the sound pressure of a sound to be detected, such as a traveling sound of the nearby vehicle, but the sound pressure of background noise, such as an engine sound of a host vehicle or wind noise, increases, the erroneous determination that a nearby vehicle is present is likely to be made. For example, one of the causes of the erroneous determination is the impossibility of determining whether the increase in the sound pressure is caused by an increase in the sound to be detected.

The sound detection device and the sound detection method according to the first embodiment determine whether the sound to be detected is included in an ambient sound on the basis of the degree of correlation between the sound pressure information items of two different frequency bands, thereby accurately determining the presence of the sound source to be detected.

FIG. 1 is a block diagram illustrating the sound detection device according to the first embodiment of the invention. As illustrated in FIG. 1, the sound detection device is provided in a vehicle and is mainly formed by an electronic control unit 10 (hereinafter, abbreviated to an ECU 10).

A microphone 1 is connected to the ECU 10. Only one microphone 1 may be connected as illustrated in FIG. 1 or a plurality of microphones 1 may be connected. The microphone 1 functions as a sound detection unit that detects an ambient sound of the vehicle. The sound detected by the microphone 1 is processed by, for example, a microphone amplifier, a frequency bandpass filter, and an A/D converter and is then input to the ECU 10.

The ECU 10 includes an intensity distribution calculation unit 11, frequency distribution calculation units 12a and 12b, distribution characteristic calculation units 13a and 13b, a distribution characteristic comparison unit 14, a sound source detection unit 15, and a detection result determination unit 16. The ECU 10 includes, for example, a CPU, a ROM, and a RAM as main components. The CPU executes a program to implement the functions of the intensity distribution calculation unit 11, the frequency distribution calculation units 12a and 12b, the distribution characteristic calculation units 13a and 13b, the distribution characteristic comparison unit 14, the sound source detection unit 15, and the detection result determination unit 16. In addition, the functions of the intensity distribution calculation unit 11, the frequency distribution calculation units 12a and 12b, the distribution characteristic calculation units 13a and 13b, the distribution characteristic comparison unit 14, the sound source detection unit 15, and the detection result determination unit 16 may be implemented by two or more ECUs.

The intensity distribution calculation unit 11 calculates an intensity distribution of a detected sound. For example, the intensity distribution calculation unit 11 performs Fourier transform on a sound signal of the detected sound to calculate an amplitude spectrum of the detected sound.

The frequency distribution calculation unit 12a calculates a frequency distribution of the detected sound in a preset frequency band A (first frequency band) on the basis of the intensity distribution of the detected sound. The frequency distribution calculation unit 12b calculates the frequency distribution of the detected sound in a frequency band B (second frequency band) different from the frequency band A on the basis of the intensity distribution of the detected sound. For example, the frequency distribution calculation units 12a and 12b calculate the probability density distribution (histogram) of the amplitude spectrum on the basis of the amplitude spectrum of the detected sound.

The frequency band A is set to a specified frequency band in which the sound to be detected is detected, for example, a frequency band of about 800 Hz to 3000 Hz in which the traveling sound of the vehicle is detected. The frequency band B is set to a frequency band which is at least partially different from the frequency band A.

The distribution characteristic calculation unit 13a calculates the distribution characteristics of the frequency band A on the basis of the frequency distribution of the frequency band A. The distribution characteristic calculation unit 13b calculates the distribution characteristics of the frequency band B on the basis of the frequency distribution of the frequency band B. For example, the distribution characteristic calculation units 13a and 13b perform γ distribution fitting on the discrete value of the probability density distribution to calculate a shape parameter and a scale parameter indicating the characteristics of a γ distribution.

Here, the probability density distribution p(x) of the γ distribution in which a shape parameter α and a scale parameter θ are known is represented by Expression (1). In addition, a maximum likelihood estimate α_{ML} of the shape parameter and a maximum likelihood estimate θ_{ML} of the scale parameter in a data sample string {x: x₁, x₂, . . . , x_{N}} are represented by Expressions (2) and (3), respectively. In the expressions, γ is calculated using an expected value E as follows: γ=log(E[x])−E[log x].

$$\begin{matrix}[ Equation 1 ] & \\ p ( x ) = \frac{1}{Γ ( a ) {θ}^{a}} {x}^{a - 1} {e}^{- \frac{x}{θ}} & ( 1 ) \\ {a}_{ML} = \frac{3 - γ + \sqrt{{( γ - 3 )}^{2} + 24 γ}}{12 γ} & ( 2 ) \\ {θ}_{ML} = \frac{E [ x ]}{{a}_{ML}} & ( 3 )\end{matrix}$$

The distribution characteristic comparison unit 14 compares the distribution characteristic of the frequency band A with the distribution characteristics of the frequency band B. The distribution characteristic comparison unit 14 compares, for example, the scale parameter of the frequency band A with the scale parameter of the frequency band B. The comparison result of the scale parameters is represented by, for example, the difference or ratio between the scale parameters.

The sound source detection unit 15 detects the sound source to be detected, such as a nearby vehicle, on the basis of the detected sound. For example, the sound source detection unit 15 detects the presence or absence and direction of the sound source on the basis of the sound pressure characteristics, frequency characteristics, and phase characteristics of the detected sound.

The detection result determination unit 16 determines the detection result of the sound source to be detected, on the basis of the comparison result of the distribution characteristics. The detection result determination unit 16 functions as a determination unit that determines whether the sound source to be detected is present around the moving body, on the basis of the degree of correlation between the sound pressure information of the first preset frequency band in the ambient sound and the sound pressure information of the second frequency band different from the first frequency band in the ambient sound. The detection result determination unit 16 is more likely to determine that the sound source to be detected is present as the degree of correlation between the sound pressure information items decreases.

The degree of correlation between the sound pressure information items is calculated on the basis of at least one of the continuity of the intensity distribution, the degree of approximation of the shapes of the probability density distributions, and the scale parameters of the probability density distributions between a sound in the first frequency band and a sound in the second frequency band. The degree of correlation between the sound pressure information items decreases as the continuity of the amplitude spectrum is reduced, as the degree of approximation of the probability density distributions decreases, or as the absolute value of the difference between the scale parameters increases or the ratio between the scale parameters is further away from 1.

The detection result determination unit 16 is more likely to determine that the sound to be detected is included in the ambient sound and the detection result of the sound source is valid as the degree of correlation between the frequency characteristics of the frequency band A and the frequency characteristics of the frequency band B decreases. For example, the detection result determination unit 16 is more likely to determine that the detection result of the sound source is valid as the absolute value of the difference between the scale parameters of the two frequency bands increases or the ratio between the scale parameters is further away from 1.

In a case in which the sound source is detected, for example, the detection result determination unit 16 determines that the detection result is invalid when the degree of correlation between the frequency characteristics is greater than a threshold value and determines that the detection result is valid when the degree of correlation between the frequency characteristics is less than the threshold value. When the sound source is detected, the valid detection result means that the sound to be detected is detected and the invalid detection result means that background noise is detected. For example, the determination result of the presence or absence of the sound source is used for driving assist for the driver of the host vehicle and for notification assist for the drivers of the nearby vehicles.

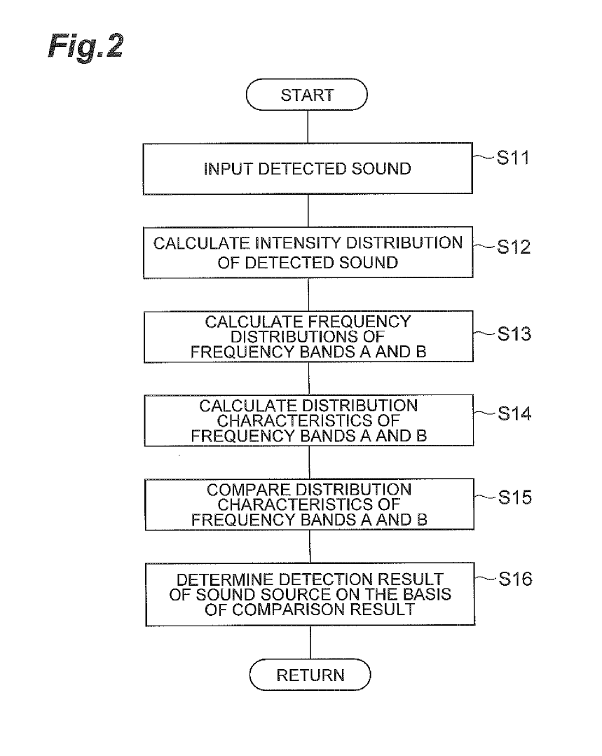

FIG. 2 is a flowchart illustrating the sound detection method according to the first embodiment. The sound detection device repeatedly performs the process illustrated in FIG. 2 in each processing cycle.

As illustrated in FIG. 2, the sound detected by the microphone 1 is input to the ECU 10 (S11). The intensity distribution calculation unit 11 calculates the intensity distribution of the detected sound (S12). The frequency distribution calculation units 12a and 12b calculate the frequency distributions of the frequency bands A and B, respectively (S13). The distribution characteristic calculation units 13a and 13b calculate the distribution characteristics of the frequency bands A and B, respectively (S14). The distribution characteristic comparison unit 14 compares the distribution characteristics of the frequency bands A and B (S15). The detection result determination unit 16 determines the detection result of the sound source to be detected, on the basis of the comparison result (S16).

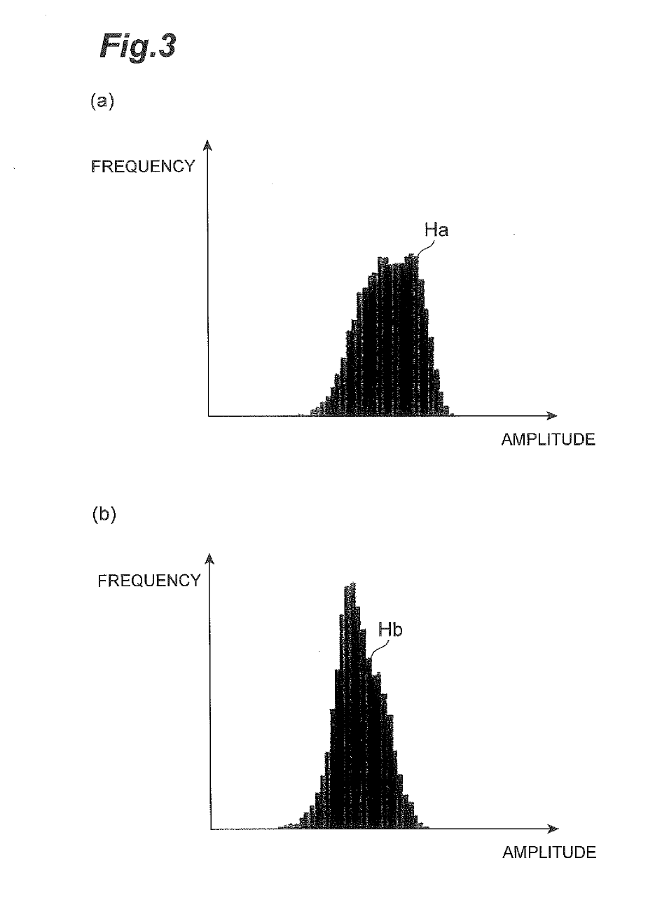

FIG. 3 is a diagram illustrating the probability density distribution that varies depending on the presence or absence of the sound to be detected which is included in an ambient sound. FIG. 3 illustrates the contrast between the probability density distribution Ha of a specified frequency band when the sound to be detected is not included in the ambient sound (a) and the probability density distribution Hb of the specified frequency band when the sound to be detected is included in the ambient sound (b).

As illustrated in FIG. 3, a sharp peak does not appear in the probability density distribution Ha when the sound to be detected is not included in the ambient sound, but a sharp peak appears in the probability density distribution Hb when the sound to be detected is included in the ambient sound. As such, the shape of the probability density distribution of the specified frequency band greatly varies depending on whether the sound to be detected is included in the ambient sound. The characteristics of the probability density distribution are reflected in the distribution characteristics which are calculated on the basis of the frequency distribution.

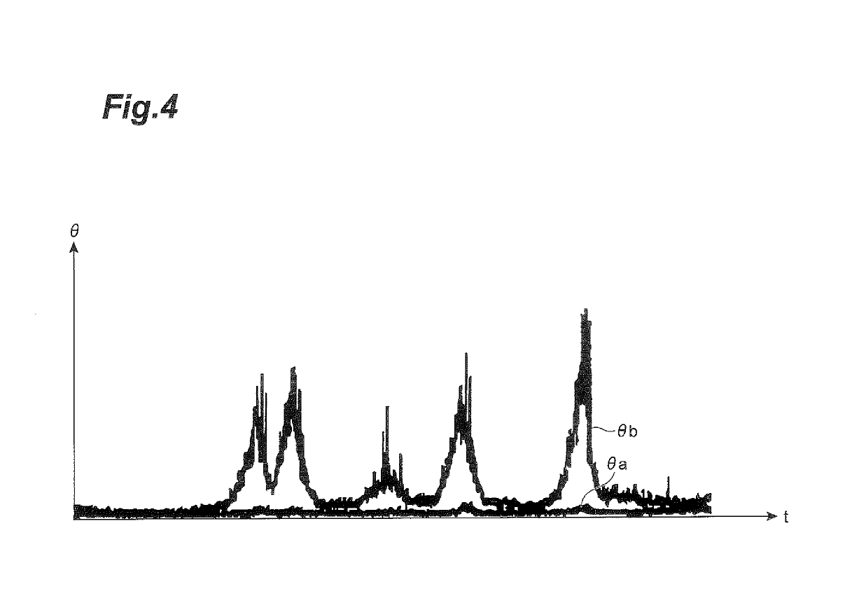

FIG. 4 is a diagram illustrating a change in the scale parameters, which vary depending on whether the sound to be detected is included in the ambient sound, over time. FIG. 4 illustrates the contrast between a change in the scale parameter θa over time when the sound to be detected is not included in the ambient sound and a change in the scale parameter θb over time when the sound to be detected is included in the ambient sound, for the probability density distribution of the specified frequency band.

As illustrated in FIG. 4, there is no significant change in the scale parameter θa when the sound to be detected is not included in the ambient sound and a sharp peak of the scale parameter θb appears each time a nearby vehicle passes when the sound to be detected is included in the ambient sound. As such, the change in the scale parameter in the specified frequency band properly reflects the presence or absence of the sound to be detected in the ambient sound.

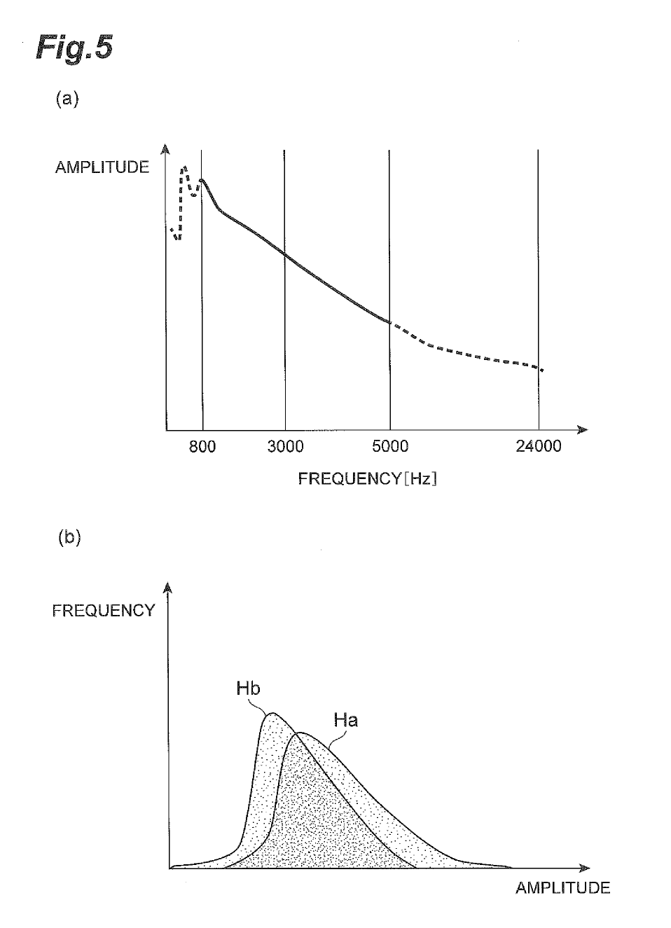

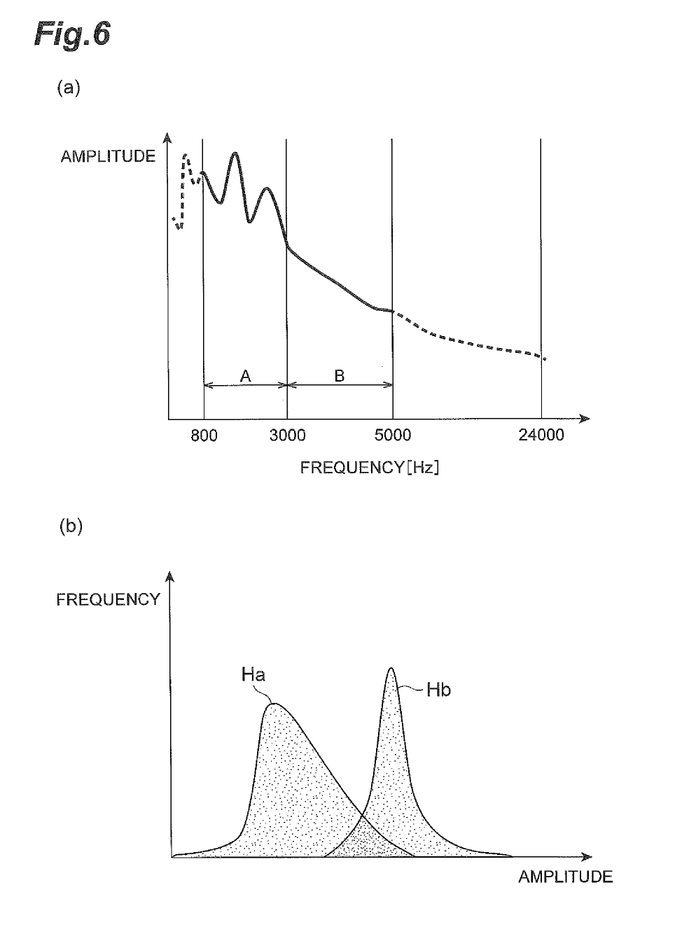

FIG. 5 is a diagram illustrating an amplitude spectrum (a) and a probability density distribution (b) when the sound to be detected is not included in the ambient sound. FIG. 6 is a diagram illustrating an amplitude spectrum (a) and a probability density distribution (b) when the sound to be detected is included in the ambient sound. In FIGS. 5 and 6, for example, the frequency band A is set to a specified frequency band of 800 Hz to 3000 Hz and the frequency band B is set to an unspecified frequency band of 3000 Hz to 5000 Hz.

As illustrated in FIG. 5(a), when the sound to be detected is not included in the ambient sound, a significant peak does not appear in the amplitudes of the frequency bands A and B and an amplitude value is continuous between the frequency bands A and B. These frequency characteristics are frequently observed when background noise, such as white noise or pink noise, is dominant in the ambient sound. As illustrated in FIG. 5(b), the shape of the probability density distribution Ha of the frequency band A is approximate to the shape of the probability density distribution Hb of the frequency band B. As a result, the shape parameters of the frequency bands A and B are approximate to each other. Therefore, the detection result determination unit is likely to determine that the degree of correlation between the sound pressure information items of the frequency bands A and B is high, the sound to be detected is not included in the ambient sound, and the detection result of the sound source is invalid, that is, the sound source to be detected is absent.

On the other hand, as illustrated in FIG. 6(a), when the traveling sound is included in the ambient sound, a significant peak appears in the amplitude of the frequency band A and the amplitude value is not continuous between the frequency bands A and B. As illustrated in FIG. 6(b), the shape of the probability density distribution Ha of the frequency band A is not approximate to the shape of the probability density distribution Hb of the frequency band B. As a result, the shape parameters of the two frequency bands A are not approximate to each other. Therefore, the detection result determination unit is likely to determine that the degree of correlation between the sound pressure information items of the frequency bands A and B is low, the sound to be detected is included in the ambient sound, and the detection result of the sound source is valid, that is, the sound source to be detected is present.

As described above, the sound detection device and the sound detection method according to the first embodiment determine whether the sound to be detected is included in the ambient sound on the basis of the degree of correlation between the sound pressure information items of two different frequency bands. Therefore, it is possible to accurately determine whether the sound source to be detected is present.

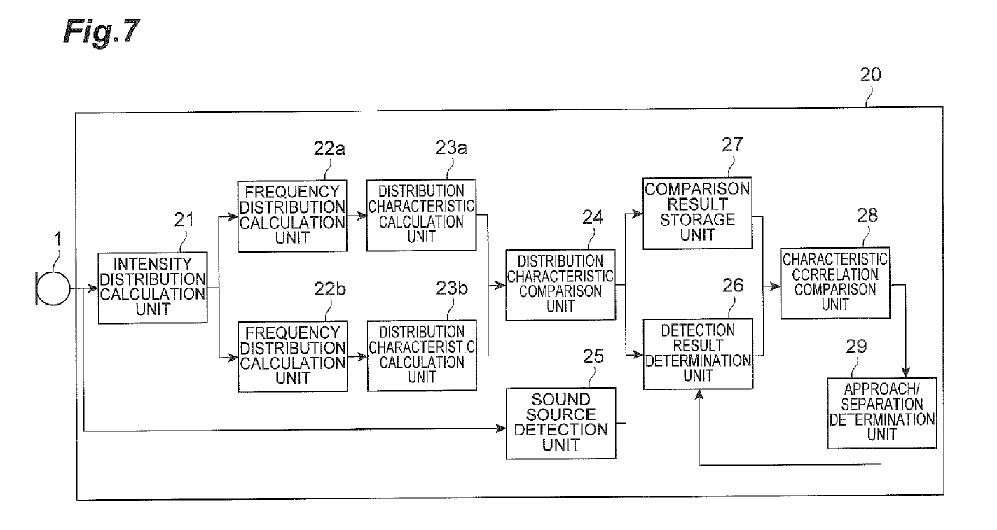

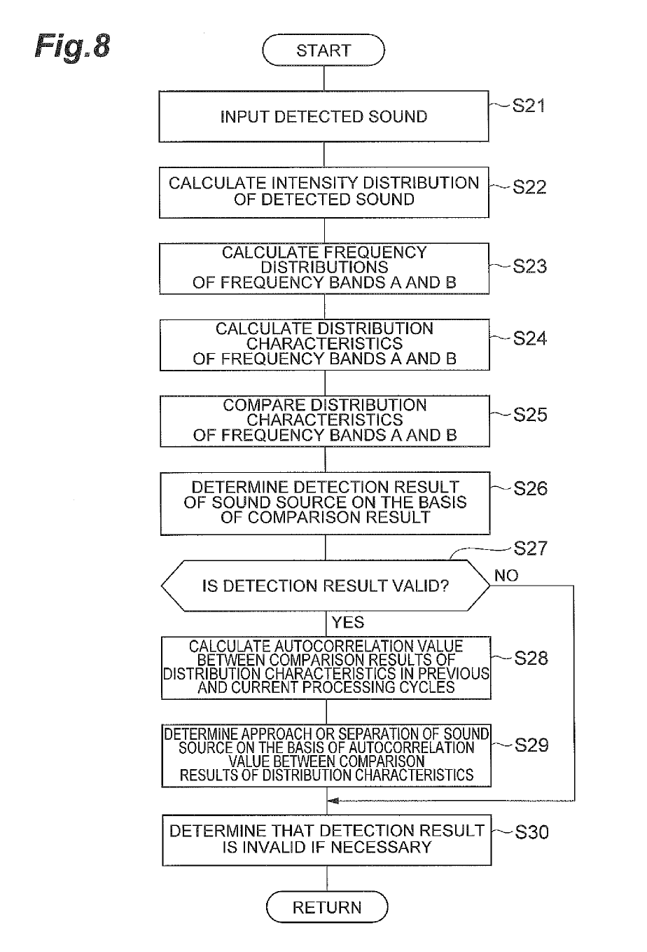

Next, a sound detection device and a sound detection method according to a second embodiment of the invention will be described with reference to FIGS. 7 and 8. In the second embodiment, the description of the same components as those in the first embodiment will not be repeated.

The sound detection device and the sound detection method according to the first embodiment determine whether the sound source to be detected is present, but cannot determine the approach or separation of the sound source. For example, the determination result of approach or separation is used to exclude a sound source which is being separated from processing targets during a driving assist process or a notification assist process.

The sound detection device and the sound detection method according to the second embodiment determine the approach or separation of the sound source to be detected, on the basis of a change in the degree of correlation between the sound pressure information items of different frequency bands over time.

FIG. 7 is a block diagram illustrating the sound detection device according to the second embodiment of the invention. As illustrated in FIG. 7, an ECU 20 of the sound detection device additionally includes a comparison result storage unit 27, a characteristic correlation calculation unit 28, and an approach/separation determination unit 29, as compared to the first embodiment. A microphone 1, an intensity distribution calculation unit 21, frequency distribution calculation units 22a and 22b, distribution characteristic calculation units 23a and 23b, a distribution characteristic comparison unit 24, and a sound source detection unit 25 have the same functions as the corresponding units in the sound detection device according to the first embodiment.

The detection result determination unit 26 determines the detection result of the sound source to be detected, on the basis of the comparison result of distribution characteristics. In addition, the detection result determination unit 26 determines that the detection result of the sound source is invalid when the sound source is determined to be separated, which will be described below.

The comparison result storage unit 27 stores the comparison result of the distribution characteristics. For example, the comparison result storage unit 27 stores the result of the comparison between a scale parameter of a frequency band A and a scale parameter of a frequency band B.

The characteristic correlation calculation unit 28 calculates an autocorrelation value between the comparison result of the distribution characteristics in the previous processing cycle and the comparison result of the distribution characteristics in the current processing cycle. For example, the characteristic correlation calculation unit 28 calculates an autocorrelation value between the comparison result of the scale parameters in the previous processing cycle and the comparison result of the scale parameters in the current processing cycle. When it is determined that the detection result of the sound source is valid, the characteristic correlation calculation unit 28 calculates the autocorrelation value.

The approach/separation determination unit 29 determines the approach or separation of the sound source to be detected, on the basis of the autocorrelation value between the comparison results of the distribution characteristics. The approach/separation determination unit 29 functions as a determination unit that determines the approach of the sound source to be detected around a moving body to the moving body or the separation of the sound source from the moving body, on the basis of the degree of correlation between the sound pressure information of a first preset frequency band in an ambient sound and the sound pressure information of a second frequency band different from the first frequency band in the ambient sound. The approach/separation determination unit 29 determines that the sound source approaches the moving body when the degree of correlation between the sound pressure information items decreases over time and determines that the sound source is separated from the moving body when the degree of correlation between the sound pressure information items increases over time.

For example, the approach/separation determination unit 29 determines that the sound source approaches when the degree of approximation between the shape parameters of the frequency bands A and B decreases over time and determines that the sound source is separated when the degree of approximation increases over time. The reason is that the domination of the frequency characteristics of the frequency band A in which the sound to be detected is detected is strengthened as the sound source approaches and is weakened as the sound source is separated.

FIG. 8 is a flowchart illustrating the sound detection method according to the second embodiment. The sound detection device repeatedly performs the process illustrated in FIG. 8 in each processing cycle. The process from S21 to S25 is substantially the same as the process from S11 to S15 in the first embodiment.

As illustrated in FIG. 8, when the detection result of the sound source is determined in S26 and the detection result of the sound source is valid (“Yes” in S27), the characteristic correlation calculation unit 28 calculates the autocorrelation value between the comparison results of the distribution characteristics in the previous and current processing cycles (S28). The approach/separation determination unit 29 determines the approach or separation of the sound source on the basis of the autocorrelation value between the comparison results of the distribution characteristics (S29). When it is determined that the sound source is separated, the detection result determination unit 26 determines that the detection result of the sound source is invalid (S30).

As described above, according to the sound detection device and the sound detection method of the second embodiment, it is possible to determine the approach or separation of the sound source to be detected, on the basis of a change in the degree of correlation between the sound pressure information items of different frequency bands over time. In addition, it is possible to invalidate the detection result of the sound source which is being separated and to appropriately perform driving assist or notification assist.

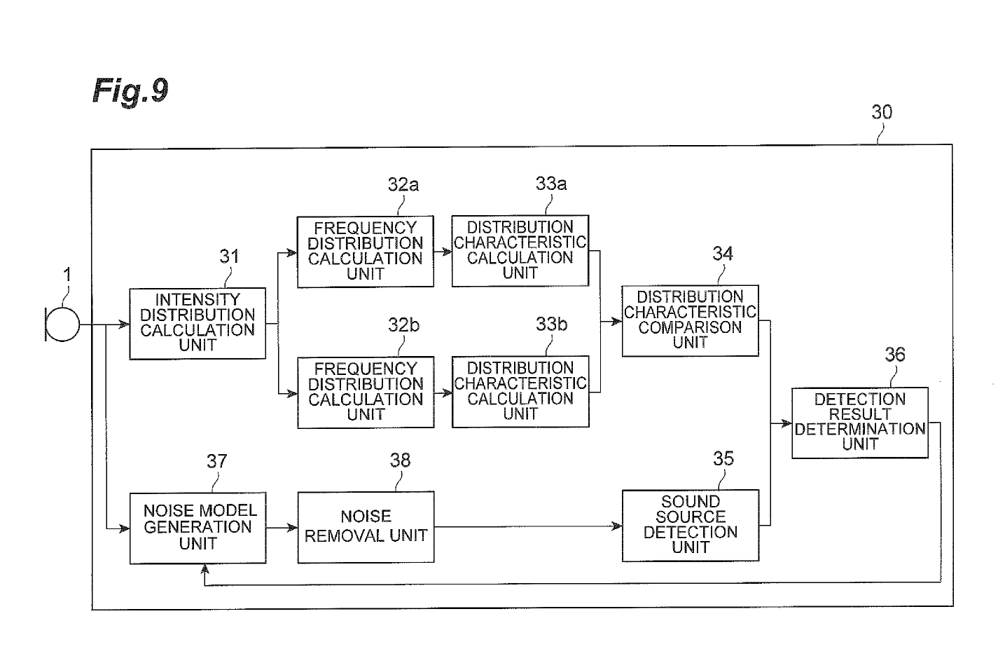

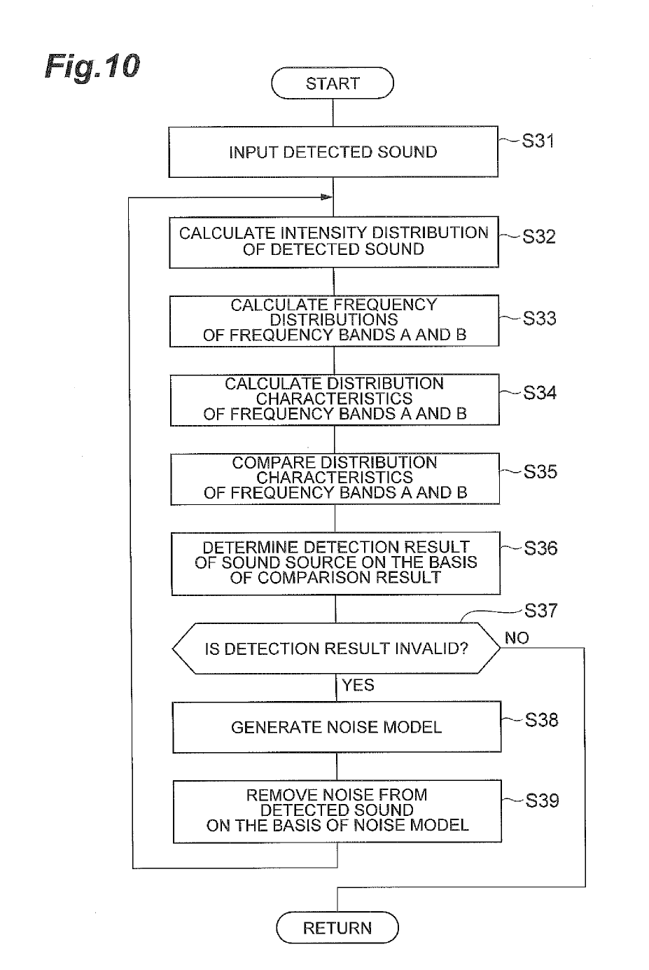

Next, a sound detection device and a sound detection method according to a third embodiment of the invention will be described with reference to FIGS. 9 and 10. In the third embodiment, the description of the same components as those in the first embodiment will not be repeated.

In the sound detection device and the sound detection method according to the first embodiment, it is determined whether the detection result of the sound source to be detected is valid on the basis of the degree of correlation between the sound pressure information items of two different frequency bands. However, for example, when it is determined that the detection result is invalid in a situation in which background noise is dominant, it is impossible to accurately determine whether a sound source is present.

The sound detection device and the sound detection method according to the third embodiment remove background noise included in an ambient sound from the ambient sound to accurately determine whether the sound source to be detected is present even in the situation in which the background noise is dominant.

FIG. 9 is a block diagram illustrating the sound detection device according to the third embodiment of the invention. As illustrated in FIG. 9, an ECU 30 of the sound detection device additionally includes a noise model generation unit 37 and a noise removal unit 38. A microphone 1, an intensity distribution calculation unit 31, frequency distribution calculation units 32a and 32b, distribution characteristic calculation units 33a and 33b, a distribution characteristic comparison unit 34, a sound source detection unit 35, and a detection result determination unit 36 have the same functions as the corresponding units in the sound detection device according to the first embodiment.

The noise model generation unit 37 generates a noise model on the basis of a detected sound. The noise model generation unit 37 functions as a generation unit that generates a sound other than the sound from the sound source to be detected, on the basis of the detected ambient sound. The noise model is generated by estimating background noise included in the detected sound. The noise model generation unit 37 generates or updates the noise model when it is determined that the detection result of the sound source to be detected is invalid.

The noise removal unit 38 removes noise from the detected sound using the noise model. The noise removal unit 38 functions as a removal unit that removes the generated sound from the detected ambient sound when it is determined that there is no sound source. The noise removal unit 38 removes noise from the detected sound using the noise model when it is determined that the detection result of the sound source is invalid. The noise removal is performed using the noise model which has been generated or updated in advance.

FIG. 10 is a flowchart illustrating the sound detection method according to the third embodiment. The sound detection device repeatedly performs the process illustrated in FIG. 10 in each processing cycle. The process from S31 to S36 is substantially the same as the process from S11 to S16 in the first embodiment.

As illustrated in FIG. 10, when the detection result of the sound source is determined in S36 and the detection result of the sound source is invalid (“Yes” in S37), the noise model generation unit 37 generates a noise model on the basis of the detected sound (S38). The noise removal unit 38 removes background noise from the detected sound in the subsequent processing cycles, using the noise model (S39).

As described above, according to the sound detection device and the sound detection method of the third embodiment, a sound other than the sound to be detected in the ambient sound, that is, background noise is removed from the ambient sound. Therefore, it is possible to accurately determine whether the sound source to be detected is present, even in a situation in which the background noise is dominant.

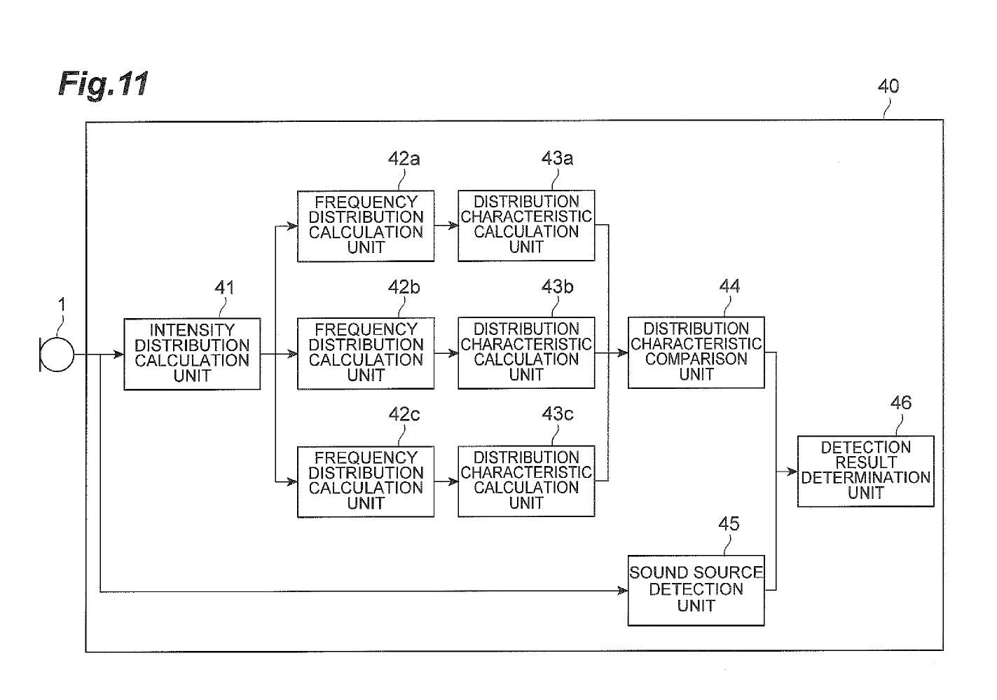

Next, a sound detection device and a sound detection method according to a fourth embodiment of the invention will be described with reference to FIGS. 11 to 17. In the fourth embodiment, the description of the same components as those in the first embodiment will not be repeated.

In the sound detection device and the sound detection method according to the first embodiment, it is determined whether the sound to be detected is included in the ambient sound on the basis of the degree of correlation between the sound pressure information items of two different frequency bands. However, for example, in some cases, in a situation in which there is a sound source other than the sound source to be detected and there is a little overlap between the frequency characteristics of a sound from the sound source and the frequency characteristics of the sound to be detected, it is impossible to appropriately determine whether the sound to be detected is included in the ambient sound.

The sound detection device and the sound detection method according to the fourth embodiment accurately determine whether the sound source to be detected is present, on the basis of the degree of correlation between the sound pressure information items of three or more different frequency bands, even in a situation in which there is a little overlap between the frequency characteristics of a sound from a sound source other than the sound source to be detected and the frequency characteristics of the sound to be detected.

FIG. 11 is a block diagram illustrating the sound detection device according to the fourth embodiment of the invention. As illustrated in FIG. 11, an ECU 40 of the sound detection device additionally includes a frequency distribution calculation unit 42c and a distribution characteristic calculation unit 43c. A microphone 1, an intensity distribution calculation unit 41, frequency distribution calculation units 42a and 42b, distribution characteristic calculation units 43a and 43b, and a sound source detection unit 45 have the same functions as the corresponding units in the sound detection device according to the fourth embodiment.

The frequency distribution calculation unit 42c calculates the frequency distribution of a detected sound in a frequency band C (third frequency band) different from frequency bands A and B on the basis of the intensity distribution of the detected sound. The frequency band C is set to a second unspecified frequency band which is at least partially different from the frequency bands A and B. It is preferable that the frequency band C is set to a high (or low) frequency side when the frequency band B is lower (or higher) than the frequency band A.

The distribution characteristic calculation unit 43c calculates the distribution characteristics of the frequency band C on the basis of the frequency distribution of the frequency band C. The distribution characteristic comparison unit 44 compares the distribution characteristics of the frequency band A, the distribution characteristics of the frequency band B, and the distribution characteristics of the frequency band C.

The detection result determination unit 46 determines the detection result of the sound source to be detected, on the basis of the comparison result of the distribution characteristics. The detection result determination unit 46 determines whether a sound source is present, on the basis of the degree of correlation among the sound pressure information of a first frequency band, the sound pressure information of a second frequency band, and the sound pressure information of a third frequency band different from the first and second frequency bands in the detected ambient sound.

The detection result determination unit 46 is more likely to determine that the sound to be detected is included in the ambient sound and the detection result of the sound source is valid as the degree of correlation between the frequency characteristics of the frequency band B and the frequency characteristics of the frequency band C increases and as the degree of correlation between the frequency characteristics of the frequency band A and the frequency characteristics of the frequency bands B and C decreases. For example, the detection result determination unit 46 determines whether the detection result of the sound source is valid on the basis of the difference or ratio between the scale parameters of three frequency bands.

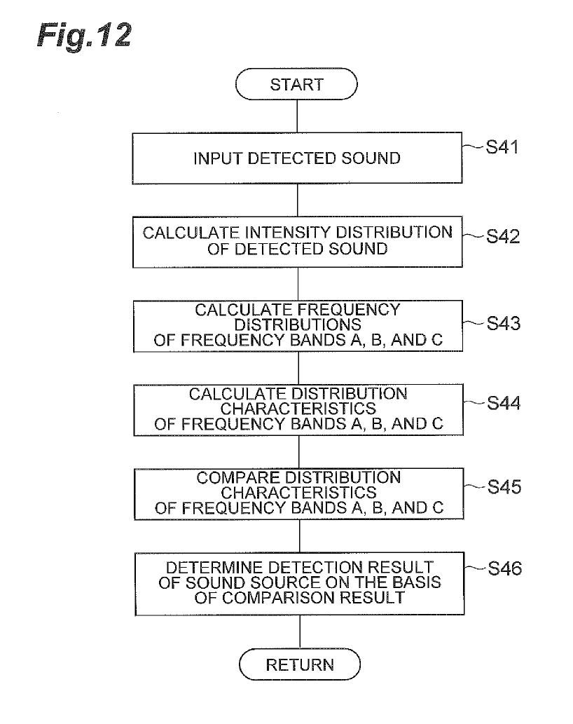

FIG. 12 is a flowchart illustrating the sound detection method according to the fourth embodiment. The sound detection device repeatedly performs the process illustrated in FIG. 12 in each processing cycle. The process in S41, S42, and S46 is substantially the same as the process in S11, S12, and S16 in the first embodiment.

As illustrated in FIG. 12, when the intensity distribution of the detected sound is calculated in S42, the frequency distribution calculation units 42a, 42b, and 42c calculate the frequency distributions of the frequency bands A, B, and C, respectively (S43). The distribution characteristic calculation units 43a, 43b, and 43c calculate the distribution characteristics of the frequency bands A, B, and C, respectively (S44). The distribution characteristic comparison unit 44 compares the distribution characteristics of the frequency bands A, B, and C (S45). When the distribution characteristics are compared, the detection result of the sound source to be detected is determined on the basis of the comparison result in S46.

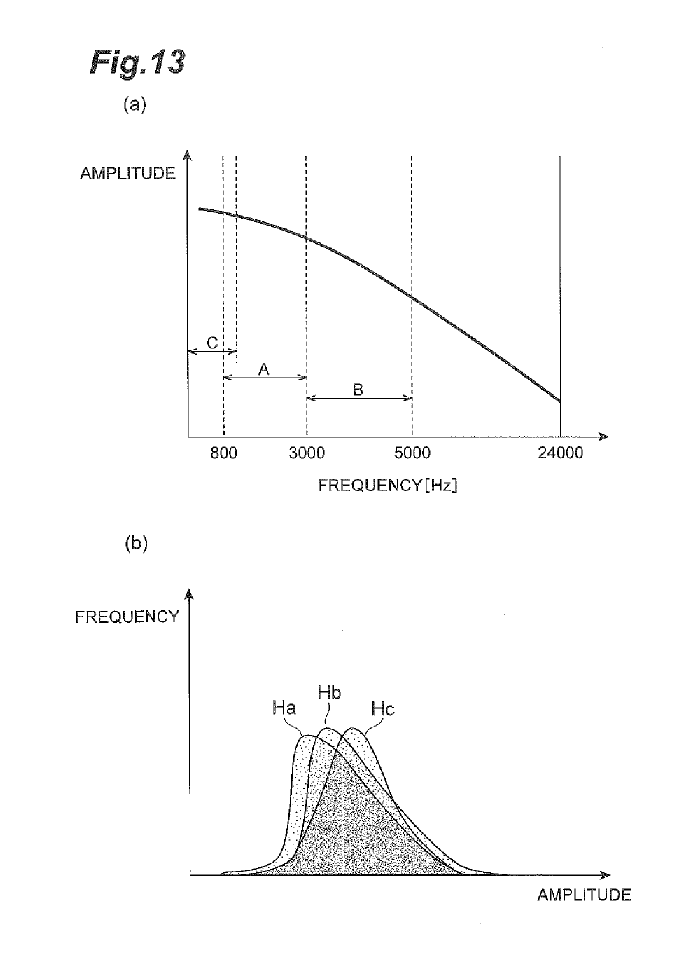

FIGS. 13 to 17 are diagrams illustrating an amplitude spectrum (a) and a probability density distribution (b) in various situations. In FIGS. 13 to 17, for example, the frequency band A is set to a specified frequency band of 800 Hz to 3000 Hz, the frequency band B is set to a first unspecified frequency band of 3000 Hz to 5000 Hz, and the frequency band C is set to a second unspecified frequency band of 0 Hz to 1200 Hz.

In the situation illustrated in FIG. 13, as illustrated in FIG. 13(a), a significant peak does not occur in the amplitudes of the frequency bands A, B, and C and an amplitude value is continuous among the frequency bands A, B, and C. As illustrated in FIG. 13(b), the shapes of the probability density distributions Ha, Hb, and He of the frequency bands A, B, and C are appropriate to each other. As a result, the shape parameters of the frequency bands A, B, and C are appropriate to each other. Therefore, it is likely to be determined that background noise is dominant and the detection result of the sound source is invalid, that is, the sound source to be detected is absent.

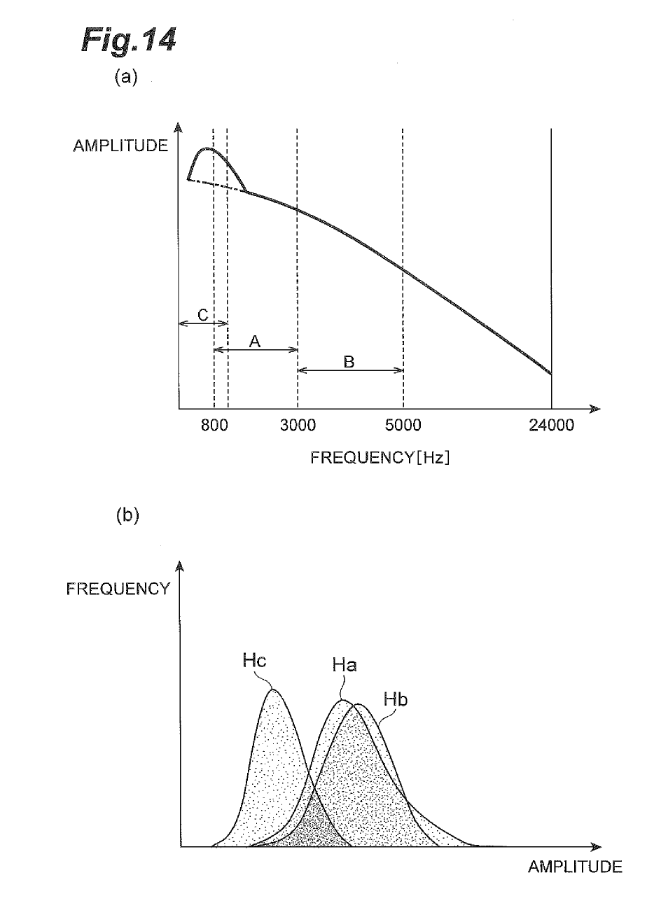

In the situation illustrated in FIG. 14, as illustrated in FIG. 14(a), a significant peak appears only in the amplitude of the frequency band C and the amplitude value is continuous between the frequency bands A and B and is not continuous between the frequency bands A and C. As illustrated in FIG. 14(b), the shape of the probability density distribution Hc of the frequency band C is not approximate to the shape of the probability density distributions Ha and Hb of the frequency bands A and B. As a result, the shape parameter of the frequency band C is not approximate to the shape parameters of the frequency bands A and B. Therefore, it is likely to be determined that background noise and a sound in the second unspecified frequency band are dominant and the detection result of the sound source is invalid, that is, the sound source to be detected is absent.

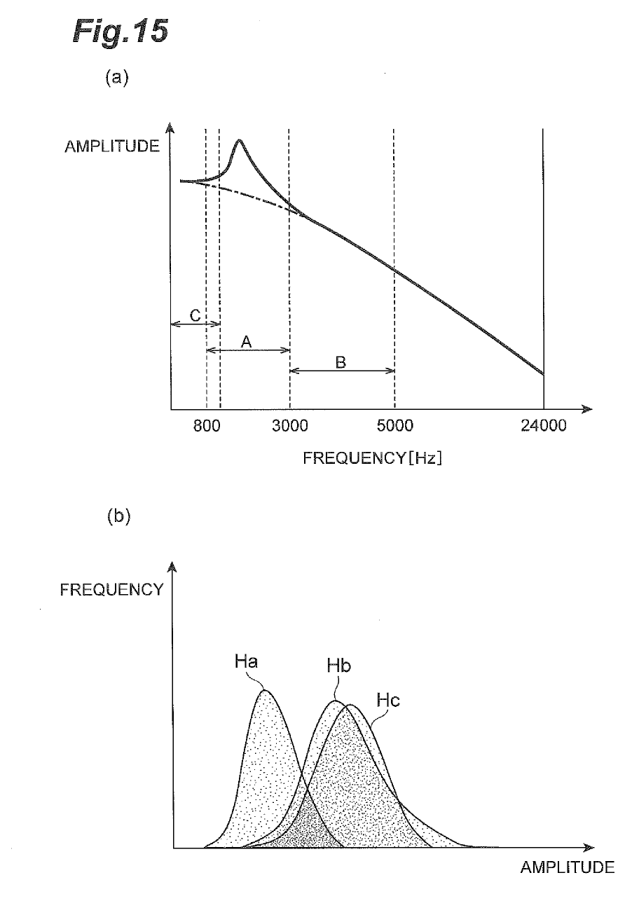

In the situation illustrated in FIG. 15, as illustrated in FIG. 15(a), a significant peak appears only in the amplitude of the frequency band A and the amplitude value is not continuous between the frequency bands A and B and between the frequency bands A and C. As illustrated in FIG. 15(b), the shape of the probability density distribution Ha of the frequency band A is not approximate to the shape of the probability density distributions Hb and He of the frequency bands B and C. As a result, the shape parameter of the frequency band A is not approximate to the shape parameters of the frequency bands B and C. Therefore, it is likely to be determined that the sound to be detected is dominant and the detection result of the sound source is valid, that is, the sound source to be detected is present.

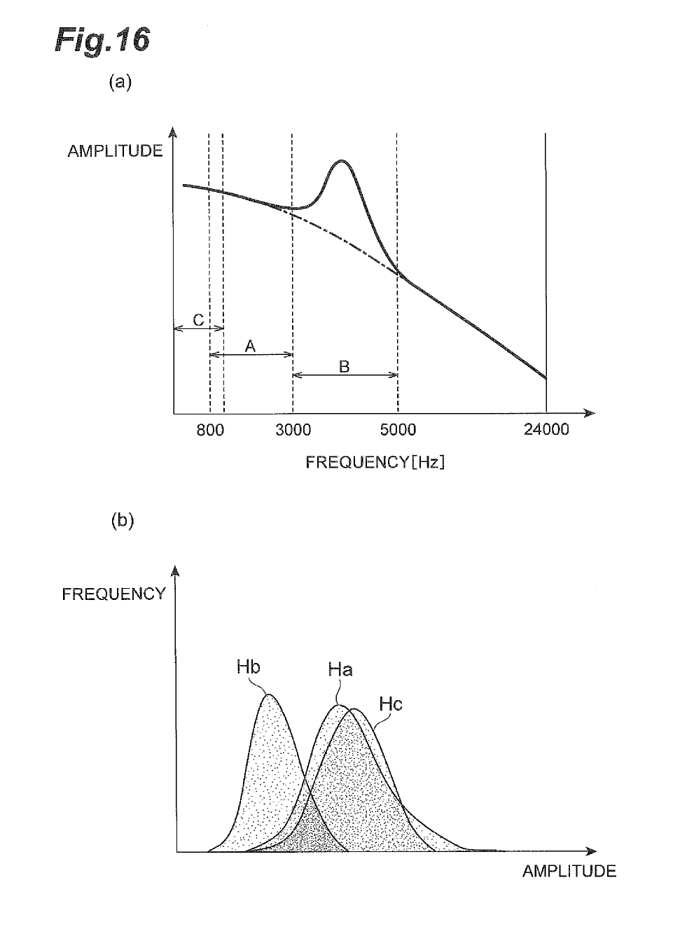

In the situation illustrated in FIG. 16, as illustrated in FIG. 16(a), a significant peak appears only in the amplitude of the frequency band B and the amplitude value is continuous between the frequency bands A and C and is not continuous between the frequency bands A and B. As illustrated in FIG. 16(b), the shape of the probability density distribution Hb of the frequency band B is not approximate to the shape of the probability density distributions Ha and He of the frequency bands A and C. As a result, the shape parameter of the frequency band B is not approximate to the shape parameters of the frequency bands A and C. Therefore, it is likely to be determined that a sound in the first unspecified frequency band is dominant and the detection result of the sound source is invalid, that is, the sound source to be detected is absent.

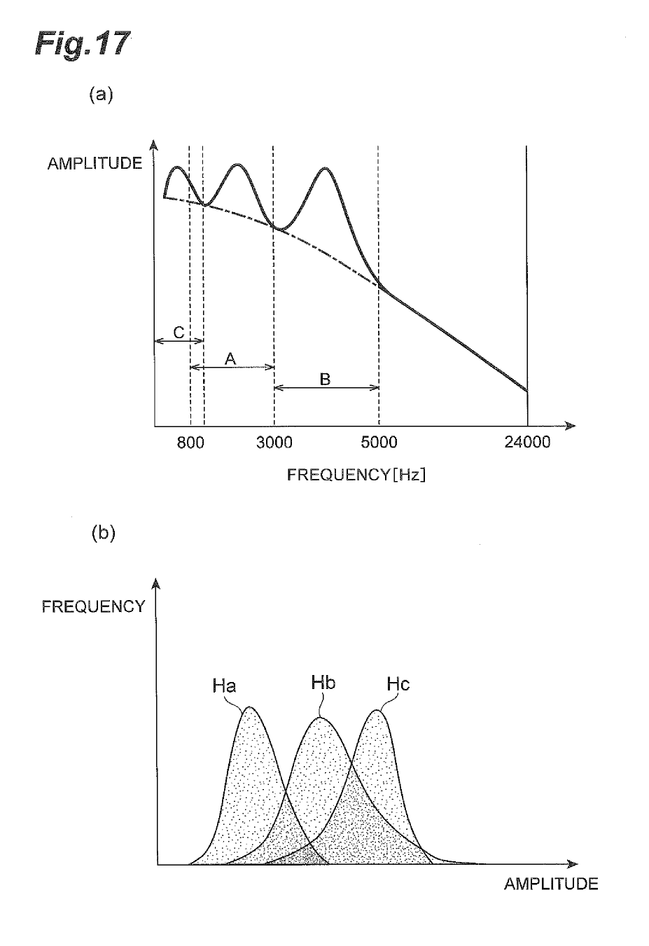

In the situation illustrated in FIG. 17, as illustrated in FIG. 17(a), a significant peak appears in the amplitudes of the frequency bands A, B, and C and the amplitude value is not continuous among the frequency bands A, B, and C. As illustrated in FIG. 17(b), the shapes of the probability density distributions Ha, Hb, and He of the frequency bands A, B, and C are not approximate to each other. As a result, the shape parameters of the frequency bands A, B, and C are not approximate to each other. Therefore, it is determined that sounds in the first and second unspecified frequency bands in addition to the sound to be detected are dominant and the situation is special.

As described above, according to the sound detection device and the sound detection method of the fourth embodiment, it is possible to accurately determine whether the sound source to be detected is present, on the basis of the degree of correlation among the sound pressure information items of three or more frequency bands, even in a situation in which there is a little overlap between the frequency characteristics of a sound from a sound source other than the sound source to be detected and the frequency characteristics of the sound to be detected.

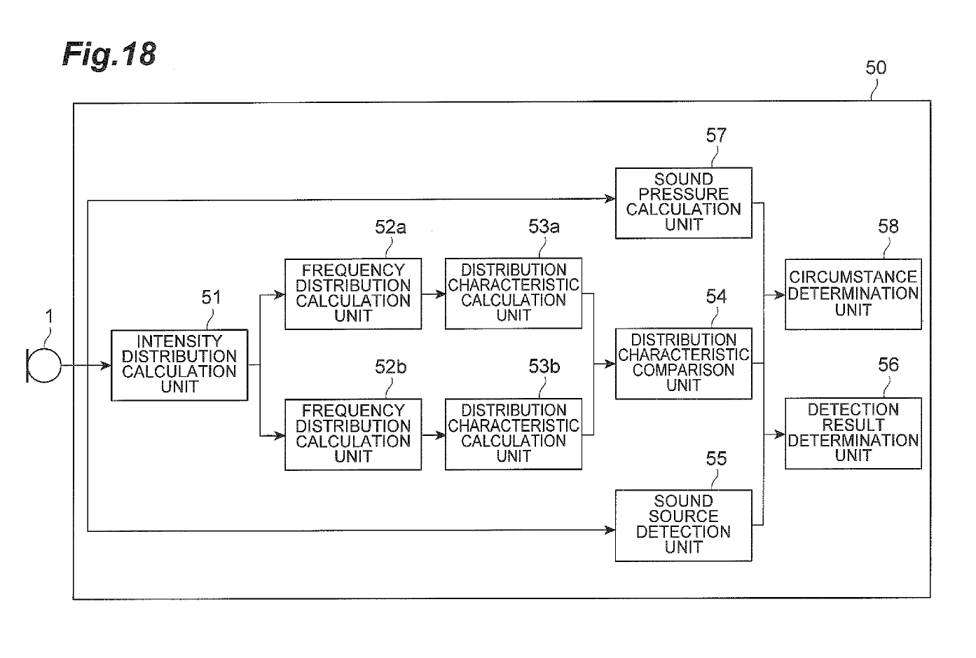

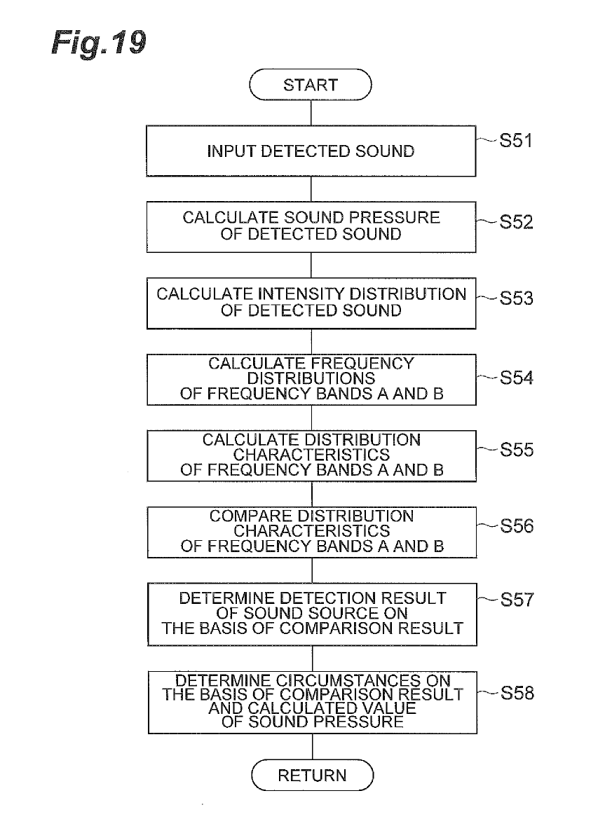

Next, a sound detection device and a sound detection method according to a fifth embodiment of the invention will be described with reference to FIGS. 18 and 19. In the fifth embodiment, the description of the same components as those in the first embodiment will not be repeated.

In the sound detection device and the sound detection method according to the first embodiment, when the sound source is detected and it is determined that the detection result is invalid, it becomes apparent that background noise is detected. However, it is impossible to determine whether the sound source to be detected can be appropriately detected in the current situation.

The sound detection device and the sound detection method according to the fifth embodiment determine whether the sound to be detected can be detected in the current situation, on the basis of the validity of the detection result and the sound pressure of an ambient sound.

FIG. 18 is a block diagram illustrating the sound detection device according to the fifth embodiment of the invention. As illustrated in FIG. 18, an ECU 50 of the sound detection device additionally includes a sound pressure calculation unit 57 and a circumstance determination unit 58. A microphone 1, an intensity distribution calculation unit 51, frequency distribution calculation units 52a and 52b, distribution characteristic calculation units 53a and 53b, a distribution characteristic comparison unit 54, a sound source detection unit 55, and a detection result determination unit 56 have the same functions as the corresponding units in the sound detection device according to the first embodiment.

The sound pressure calculation unit 57 calculates the sound pressure of a detected sound.

The circumstance determination unit 58 determines the circumstances of the sound detection device on the basis of the comparison result of the distribution characteristics and the sound pressure of the detected sound. The circumstance determination unit 58 functions as a second determination unit that determines whether the sound detection device is in a situation in which it can detect the sound source to be detected on the basis of the detection result of the sound source to be detected and the sound pressure of a detected ambient sound.

The circumstance determination unit 58 is more likely to determine that the sound detection device is in a situation in which it cannot appropriately detect the sound source as the distribution characteristics of the frequency bands A and B become closer to each other and as the sound pressure of the detected sound increases. That is, the circumstance determination unit 58 determines that the sound source cannot be appropriately detected when the sound to be detected is not included in the ambient sound and the sound pressure is equal to or greater than a prescribed value. For example, the determination result of the circumstances of background noise is used in order to suppress driving assist or notification assist in a situation in which the sound to be detected cannot be appropriately detected, thereby avoiding inappropriate assist due to a detection error.

FIG. 19 is a flowchart illustrating the sound detection method according to the fifth embodiment. The sound detection device repeatedly performs the process illustrated in FIG. 19 in each processing cycle. The process in S51 and S53 to S57 is substantially the same as the process from S11 to S16 in the first embodiment.

As illustrated in FIG. 19, when a detected sound is input in S51, the sound pressure calculation unit 57 calculates the sound pressure of the detected sound (S52). When the detection result of the sound source to be detected is determined in S57, the circumstance determination unit 58 determines the circumstances of the sound detection device on the basis of the comparison result of the distribution characteristics and the calculation result of the sound pressure (S58).

Therefore, it is possible to determine whether the sound detection device is in a situation in which it can appropriately detect the sound source to be detected, on the basis of the validity of the detection result and the sound pressure of the ambient sound.

The above-described embodiments are preferred embodiments of the sound detection device and the sound detection method according to the invention. The sound detection device and the sound detection method according to the invention are not limited to the embodiments. The sound detection device and the sound detection method according to the invention may be modified, without departing from the scope and spirit of the claims, or may be applied to other techniques.

The first to fifth embodiments may be combined with each other. For example, in the second embodiment, it may not be determined whether there is a sound source to be detected and the approach or separation of the sound source may be directly determined.

For example, in the second embodiment, after a sound other than the sound from the sound source to be detected is removed from the ambient sound, the approach or separation of the sound source may be determined. Alternatively, after it is determined whether there is a sound source to be detected on the basis of the sound pressure information items of three or more frequency bands, the approach or separation of the sound source may be determined. Alternatively, after it is determined whether the sound detection device is in a situation in which it can detect the sound source to be detected, the approach or separation of the sound source may be determined.

In the above-described embodiments, the case in which γ distribution fitting is used to calculate the distribution characteristics has been described. However, other distribution fitting methods may be used to calculate the distribution characteristics.

The sound detection device and the sound detection method according to the embodiments of the invention may be applied to a moving body, such as a moving robot, other than the vehicle.

### REFERENCE SIGNS LIST

1: MICROPHONE
10, 20, 30, 40, 50: ELECTRONIC CONTROL UNIT (ECU)
11, 21, 31, 41, 51: INTENSITY DISTRIBUTION CALCULATION UNIT
12a, 12b, 22a, 22b, 32a, 32b, 42a, 42b, 42c, 52a, 52b: FREQUENCY DISTRIBUTION CALCULATION UNIT
13a, 13b, 23a, 23b, 33a, 33b, 43a, 43b, 43c, 53a, 53b: DISTRIBUTION CHARACTERISTIC CALCULATION UNIT
14, 24, 34, 44, 54: DISTRIBUTION CHARACTERISTIC COMPARISON UNIT
15, 25, 35, 45, 55: SOUND SOURCE DETECTION UNIT
16, 26, 36, 46, 56: DETECTION RESULT DETERMINATION UNIT
27: COMPARISON RESULT STORAGE UNIT
28: CHARACTERISTIC CORRELATION CALCULATION UNIT
29: APPROACH/SEPARATION DETERMINATION UNIT
37: NOISE MODEL GENERATION UNIT
38: NOISE REMOVAL UNIT
57: SOUND PRESSURE CALCULATION UNIT
58: CIRCUMSTANCE DETERMINATION UNIT

1. A sound detection device that is provided in a moving body, comprising:
a sound detection unit configured to detect an ambient sound of the moving body; and
a determination unit configured to determine at least one of the presence of a sound source to be detected around the moving body, the approach of the sound source to the moving body, and the separation of the sound source from the moving body, on the basis of a degree of correlation between sound pressure information of a first preset frequency band in the ambient sound detected by the sound detection unit and sound pressure information of a second frequency band different from the first frequency band in the ambient sound detected by the sound detection unit.

2. The sound detection device according to claim 1,
wherein the determination unit determines that the sound source approaches the moving body when the degree of correlation between the sound pressure information items decreases over time and determines that the sound source is separated from the moving body when the degree of correlation between the sound pressure information items increases over time.

3. The sound detection device according to claim 1, further comprising:
a generation unit configured to generate a sound other than a sound from the sound source on the basis of the ambient sound detected by the sound detection unit; and
a removal unit configured to remove the sound generated by the generation unit from the detected ambient sound when it is determined that the sound source is not present.

4. The sound detection device according to claim 1, further comprising:
a second determination unit configured to determine whether the sound detection device is in a situation in which the sound detection device can detect the sound source, on the basis of the detection result of the sound source and the sound pressure of the ambient sound detected by the sound detection unit.

5. The sound detection device according to claim 1,
wherein the determination unit is more likely to determine that the sound source is present as the degree of correlation between the sound pressure information items decreases.

6. The sound detection device according to claim 1,
wherein the degree of correlation between the sound pressure information items is calculated on the basis of at least one of the continuity of an intensity distribution, a degree of approximation of the shapes of probability density distributions, and scale parameters of the probability density distributions between a sound in the first frequency band and a sound in the second frequency band.

7. The sound detection device according to claim 1,
wherein the determination unit determines at least one of the presence of the sound source, the approach of the sound source to the moving body, and the separation of the sound source from the moving body, on the basis of a degree of correlation among the sound pressure information of the first frequency band, the sound pressure information of the second frequency band, and sound pressure information of a third frequency band different from the first and second frequency bands in the ambient sound detected by the sound detection unit.

8. The sound detection device according to claim 1,
wherein the moving body is a vehicle.

9. A sound detection method using a sound detection device provided in a moving body, comprising:
a sound detection step of detecting an ambient sound of the moving body; and
a determination step of determining at least one of the presence of a sound source to be detected around the moving body, the approach of the sound source to the moving body, and the separation of the sound source from the moving body, on the basis of a degree of correlation between sound pressure information of a first preset frequency band in the ambient sound detected in the sound detection step and sound pressure information of a second frequency band different from the first frequency band in the ambient sound detected in the sound detection step.
